(19) United States
(12) Patent Application Publication
(10) Pub. No.: US 2016/0312826 A1
(43) Pub. Date: Oct. 27, 2016

(54) PROTECTIVE BEARING, BEARING UNIT, AND VACUUM PUMP

(71) Applicant: Edwards Japan Limited, Yachiyo-shi, Chiba (JP)

(72) Inventors: Toshiaki Kawashima, Yachiyo-shi, Chiba (JP); Isao Nakagawa, Kitakyushu (JP)

(73) Assignees: Edwards Japan Limited, Yachiyo-shi, Chiba (JP); Edwards Japan Limited, Yachiyo-shi, Chiba (JP)

(21) Appl. No.: 15/028,095

(22) PCT Filed: Sep. 10, 2014
(86) PCT No.: PCT/JP2014/073888

§ 371 Date: Apr. 8, 2016

(30) Foreign Application Priority Data
Oct. 25, 2013 (JP) 2013-222336
Dec. 13, 2013 (JP) 2013-258398

(51) Int. Cl. F16C 32/04; F04D 27/00; F16C 19/06; F04D 19/04

(52) U.S. Cl. CPC F16C 32/0402; F04D 19/042; F04D 19/048; F04D 27/00; F16C 32/0442; F16C 19/06; F05D 2240/515; F05D 2240/30; F05D 2240/511; F05D 2260/941; F16C 2360/45; F16C 2300/62

(57) ABSTRACT

To provide a protective bearing, a bearing unit, and a vacuum pump that are configured to prevent a touchdown bearing from co-rotating with the rotation of a rotor that is supported in a levitated state and a non-contact state. Slits are formed in the radial direction at four sections on the inner side of a securing member. A pair of permanent magnets of the same polarity is fixed to the upper surface of each of the four regions partitioned by the slits. The inner rim of the securing member has projections that are formed circumferentially downward. An attractive force is generated between an outer ring and an inner ring. An attractive force is also generated between the projections projecting toward the inner end of the securing member and the inner ring. Due to this configuration, even when a rotational torque is applied to the inner ring of the touchdown bearing as a result the rotation of the rotating body, co-rotation of the inner ring does not occur due to a large holding torque.

This application is a national stage entry under 35 U.S.C. §371 of International Application No. PCT/JP2014/073888, filed Sep. 10, 2014, which claims the benefit of JP Application 2013-222336, filed Oct. 25, 2013, and JP Application 2013-258398, filed Dec. 13, 2013. The entire contents of International Application No. PCT/JP2014/073888, JP Application 2013-222336, and JP Application 2013-258398 are incorporated herein by reference.

### TECHNICAL FIELD

The present disclosure relates to a protective bearing, a bearing unit, and a vacuum pump, and particularly to a protective bearing, a bearing unit, and a vacuum pump that are configured to prevent a touchdown bearing from co-rotating with the rotation of a rotor that is supported in a levitation state and a non-contact state.

### BACKGROUND

With the developments of electronics, there has been a rapid increase in demand for semiconductors such as memories and integrated circuits. Such semiconductors are manufactured by doping highly pure semiconductor substrates with impurities to provide electrical properties and the like thereto or by forming microscopic circuit patterns and stacking them on semiconductor substrates. These tasks need to be performed in a high-vacuum chamber in order to avoid dusts and the like in the air. It is common to use a vacuum pump as a pumping apparatus to vacuate this chamber, but a turbo-molecular pump, a type of vacuum pump, is used very frequently due to ease of maintenance and the like.

A semiconductor manufacturing step entails a large number of steps of applying various process gases to a semiconductor substrate. A turbo-molecular chamber is used not only for vacuating the chamber but also for discharging the process gasses from the chamber. The turbo-molecular pump is also used to make the environment inside the chamber such as an electron microscope highly vacuum for the purpose of preventing refraction and the like of an electron beam which occurs due to the presence of powder dusts and the like in a facility such as an electron microscope.

In the turbo-molecular pump, a high-frequency motor rotates a rotor shaft that is provided at the center of a rotating body, while a magnetic bearing unit supports the rotating body in a levitation state and a non-contact state. The turbo-molecular pump is also provided with a touchdown bearing so that, when the rotating body cannot be magnetically levitated for some reason such as when the rotating body rotates abnormally or when a power outage occurs, the rotating body can be shifted and stopped safely in a non-levitation state.

A touchdown bearing is configured as an annular ball bearing such as the one shown in FIG. 28. As shown in FIG. 28, an outer ring 11 of a touchdown bearing 10 is fixed to the end portion of a stator column which is not shown. In a case where the motor is, for example, a DC brushless motor, permanent magnets are attached to embed in a circumferential surface of a rotor shaft 113 to function as a rotor.

When assembling the turbo-molecular pump, the rotor shaft 113 is inserted into the cylindrical stator column that is provided with the touchdown bearing 10. Therefore, the permanent magnets of the motor, which are provided in the rotor shaft 113, pass through the inner side of the touchdown bearing 10. In a case where the material of an inner ring 13 and the outer ring 11 of the touchdown bearing 10 are magnetic, then the inner ring 13 and the outer ring 11 are magnetized. In a case where balls 15 interposed between the inner ring 13 and the outer ring 11 are magnetic, the balls 15 are magnetized in the same way.

When the touchdown bearing 10 is magnetized, the magnetism of the inner ring 13 creates closed magnetic paths, indicated by the solid lines in FIG. 28, between the outer ring 13 and the rotor shaft 113. In addition, closed magnetic paths, indicated by the dotted lines, are created between the inner ring 13 and the outer ring 11. In view of heat resistance, abrasion resistance and the like, the recent trend is to make the balls 15 with ceramic material that is highly durably and nonmagnetic.

However, if the balls 15 are made of ceramic material, the magnetic flux density of the closed magnetic paths indicated by the dotted lines is particularly weak. Due to the crossing of the magnetism indicated by the solid lines, rotating the rotor shaft 113 causes an induced current inside the rotor shaft 113. Then, an attractive force is generated between this induced current and a magnetic field passing through the rotor shaft 113. Due to such an interaction with the rotor shaft 113, so-called “co-rotation” occurs in which the inner ring 13 of the touchdown bearing 10 rotates in conjunction with the rotation of the rotor shaft 113 even when the rotor shaft 113 is supported in a non-contact state.

Co-rotation of the inner ring 13 of the touchdown bearing 10 is likely to reduce the life of the bearing due to frictions and the like. Co-rotation of the inner ring 13 is also likely to cause noise and vibrations. In order to prevent such co-rotation, there has conventionally been proposed a method for increasing the rotational resistance by applying a vacuum grease to the touchdown bearing 10, or enabling easy passage of the magnetic flux through the closed magnetic paths of the inner ring 13 and the outer ring 11 to reduce the rotational momentum generated between the rotor shaft 113 and the inner ring 13 when the balls 15 are made of non-magnetic ceramic material, so that the holding torque of the touchdown bearing 10 becomes greater than the co-rotation force of the inner ring 13 (Japanese Patent Application Laid-open No. 2008-38935).

### SUMMARY

According to Japanese Patent Application Laid-open No. 2008-38935, there is a limit to the level of magnetization of the inner ring and the outer ring because the inner ring and the outer ring are equidistant from each other over the entire circumference with the ceramic balls there between. Due to such a limit, the magnetic force does not much grow between the inner ring and the outer ring. Consequently, there is a possibility that a sufficient large holding torque for preventing the co-rotation of the inner ring cannot be obtained.

In view of this, when the inner ring of the touchdown bearing is strongly magnetized by the permanent magnets of the motor when passing the rotor shaft through the touchdown bearing in the step of assembling the pump, the co-rotation often occurs. Even in a case of magnetizing a touchdown bearing having magnetic balls, the opposing circumferential surfaces of the inner ring and the outer ring of this touchdown bearing are apart from each other by the diameter of the balls, lowering the concentration of the magnetic flux density per unit area. Therefore, the magnetic force that is generated between the inner ring and the outer ring is relatively weak. Consequently, co-rotation often occurs when the inner ring of the touchdown bearing rotates smoothly.

The present disclosure was contrived in view of these conventional problems, and an object thereof is to provide a protective bearing, a bearing unit, and a vacuum pump that are configured to prevent a touchdown bearing from co-rotating with the rotation of a rotor that is supported in a levitated state and a non-contact state.

In some examples, the present disclosure describes a protective bearing for protecting a rotating body when the rotating body is stopped or when an abnormality occurs in a bearing, wherein at least a part of the protective bearing is magnetized by magnetizing means.

In some examples, the present disclosure describes characterized in that a securing member for securing the protective bearing is provided.

In some examples, the protective bearing according to the present disclosure is characterized in that a first projection located between an inner ring and an outer ring of the protective bearing is formed in the securing member.

Magnetization of the first projection of the securing member can generate an attractive force between the first projection and the inner ring of the bearing.

In some examples, the protective bearing according to the present disclosure is characterized in being provided with a permanent magnet for magnetizing the protective bearing through the securing member or by coming into contact with the protective bearing.

The permanent magnet magnetizes the bearing through the securing member. Alternatively, the permanent magnet magnetizes the bearing by coming into contact with the bearing. In so doing, the securing member and an outer ring of a touchdown bearing are magnetized to the same pole. An inner ring, on the other hand, is magnetized to the other pole through balls. As a result, an attractive force is generated between the outer ring and the inner ring. Therefore, even when a rotational momentum is generated between the rotating body and the bearing as a result of the bearing being co-rotated with the rotation of the rotating body, the rotational momentum is inhibited substantially by a strong holding torque. In other words, even when a rotational momentum is applied to the inner ring of the bearing, co-rotation does not occur because the holding torque is large. Moreover, when the rotating body does not levitate and operates as the original protective bearing due to malfunction or the like of the rotating body or bearing, the rotating body rotates without difficulties because a torque equivalent to or greater than the holding torque is applied to the bearing. Furthermore, when the rotating body starts rotating in resistance to the holding torque, a particularly large brake torque does not occur, preventing seizure of the bearing. Note that the rotating body may be of an inner type or an outer type, and the bearing may be a magnetic bearing or a hydrodynamic bearing.

In some examples, the protective bearing according to the present disclosure has a second projection that is provided on the opposite side to the first projection, across a rolling element of the protective bearing, wherein the first projection and the second projection are magnetized by the permanent magnet.

Because an attractive force acts between the first projection and the inner ring of the bearing and another attractive force acts between the second projection and the inner ring of the bearing, a sufficient holding torque can be obtained. Therefore, the balls can be made non-magnetic.

In the protective bearing according to the present disclosure, the permanent magnet is provided in plurality around the securing member, the securing member has slits in a predetermined shape that segment the permanent magnets, and at least one of the permanent magnets is provided in a region segmented by the slits.

Providing the slits leads to an increase of the magnetic resistance, making it difficult for the magnetic flux to pass through the slit between the regions adjacent to each other. Therefore, leakage of the magnetic flux between the magnetic poles of the adjacent magnets can be reduced. Consequently, a sufficient attractive force can be generated between the outer ring and the inner ring.

In some examples, the protective bearing according to the present disclosure is characterized in that a motor for driving the rotating body is provided, wherein the number of the slits matches the number of magnetic poles of the motor.

The number of magnetic poles of the outer ring can be conformed to the number of magnetic poles of the inner ring by conforming the number of slits to the number of magnetic poles of the motor. Thus, the attractive force acting between the outer ring and the inner ring can be made uniform, and a sufficiently large holding torque can be obtained.

In some examples, the permanent magnet of the protective bearing according to the present disclosure is fixed to a surface of the securing member or embedded in the securing member or a stator.

According to this configuration, the securing member or the outer ring can reliably be magnetized by the permanent magnet.

In some examples, the permanent magnet of the protective bearing according to the present disclosure is characterized in being provided in contact with the outer ring of the protective bearing.

According to this configuration, the outer ring of the bearing can reliably be magnetized by the permanent magnet.

In some examples, the protective bearing according to the present disclosure has the outer ring thereof magnetized.

Magnetizing the outer ring can eliminate the need of parts such as the permanent magnets.

In some examples, in the protective bearing according to the present disclosure, the securing member is magnetized.

Magnetizing the securing member can eliminate the need of parts such as the permanent magnets.

In some examples, in the protective bearing according to the present disclosure, at least either the outer circumference of the inner ring or the inner circumference of the outer ring is provided with a third projection.

As a result of intensively magnetizing the third projection, an attractive force is generated as a strong positioning force between the inner ring and the outer ring. Therefore, even when an attractive force occurs between the rotating body and the bearing as a result of the bearing being co-rotated with the rotation of the rotating body, the attractive force can be inhibited substantially by the strong holding torque. In other words, even when a rotational momentum is applied to the inner ring of the bearing, co-rotation does not occur because the holding torque is large. Moreover, when the rotating body does not levitate and operates as the original protective bearing due to malfunction or the like of the rotating body or bearing, the rotating body rotates without difficulties because a torque equivalent to or greater than the holding torque is applied to the bearing. Furthermore, when the rotating body starts rotating in resistance to the holding torque, a particularly large brake torque does not occur, preventing seizure of the bearing. Note that the rotating body may be of an inner type or an outer type, and the bearing may be a magnetic bearing or a hydrodynamic bearing.

In some examples, a rolling element of the protective bearing according to the present disclosure is made of nonmagnetic material.

In some examples, a bearing unit according to the present disclosure has the protective bearing of any one of the above examples, wherein the rotating body is driven rotationally by a motor while being supported in a state of levitation, the protective bearing protects the rotating body in a state of non-levitation, the protective bearing has a third projection on at least either the outer circumference of the inner ring or the inner circumference of the outer ring, and the third projection is magnetized by the magnetizing means.

In some examples, in the bearing unit according to the present disclosure, the magnetizing means is a permanent magnet provided in the motor.

Causing such magnetization using the permanent magnet provided in the motor can eliminate the need of a special device for causing magnetization.

In some examples, in the bearing unit according to the present disclosure, the magnetizing means is a magnetizer provided on the outer circumference of the protective bearing.

Reliable magnetization can be achieved through magnetization by the magnetizer. Magnetization can be done with a ferromagnetic field.

In some examples, in the bearing unit according to the present disclosure, the magnetizing means is a permanent magnet that is provided in the upper portion or lower portion of the protective bearing so as to have magnetic poles oriented in a radial direction.

Stable magnetization is always possible by performing magnetization using the permanent magnet provided in the upper portion or lower portion of the bearing.

In some examples, the bearing unit according to the present disclosure has a securing member for securing the upper portion or lower portion of the protective bearing, wherein a fourth projection opposing the third projection is provided in the securing member, and the third projection and the fourth projection are magnetized by the magnetizing means.

In some examples, the same effects as those of claims 12 and the like can be achieved through magnetization of the third projection and the fourth projection.

In some examples, the bearing unit according to the present disclosure is a bearing unit that has the protective bearing of any one of the above examples and the rotating body that is driven rotationally by a motor while being supported in a state of levitation, wherein at least one notched groove is formed on a surface of the rotating body that opposes the protective bearing.

The presence of the notched groove limits an eddy current path that occurs on the surface of the rotating body, reducing the eddy current. This weakens the electromagnetic induction action that occurs between the rotating body and the inner ring of the bearing, resulting in a reduction of the rotational momentum which is a cause of the co-rotation. The co-rotation can be prevented more effectively by combining the configuration example of claim 19 with each of the configuration examples of claims 1 to 13. Such combination can reduce the magnetic forces of the permanent magnet necessary to prevent the co-rotation, the outer ring of the bearing that functions as a magnetizing component, and the securing member.

In some examples, a vacuum pump according to the present disclosure has the protective bearing of any one of the above examples.

In some examples, the vacuum pump according to the present disclosure has the bearing unit of any one of the above examples.

As described above, according to the present disclosure, the protective bearing is configured with the permanent magnets that magnetize the bearing through the securing member or by coming into contact with the bearing. Thus, the securing member and the outer ring of the touchdown bearing are magnetized to the same pole. The inner ring, on the other hand, is magnetized to the opposite pole through balls. As a result, an attractive force is generated between the outer ring and the inner ring. According to such configuration, even when an attractive force occurs between the rotating body and the bearing as a result of the bearing being co-rotated with the rotation of the rotating body, the attractive force can be inhibited substantially by the strong holding torque. Thus, even when a rotational momentum is applied to the inner ring of the bearing, the co-rotation does not occur because the holding torque is large.

### BRIEF DESCRIPTION OF THE DRAWINGS

FIG. 1 is a longitudinal section of a turbo-molecular pump according to a first embodiment of the present disclosure;

FIG. 2 is a longitudinal section showing the periphery of a touchdown bearing;

FIG. 3 is a plan view of the touchdown bearing;

FIG. 4 is a diagram showing a method of magnetization by a magnetizer;

FIG. 5 is a longitudinal section showing a method of magnetization by permanent magnets provided in a radial direction;

FIG. 6 is a transmissive layout drawing showing the touchdown bearing from above;

FIG. 7 shows an example in which a projection is provided on a surface of a securing member that faces an inner ring of the touchdown bearing;

FIG. 8 is a longitudinal section showing the periphery of a touchdown bearing according to a second embodiment;

FIG. 9 is a plan view of a securing member;

FIG. 10 is a diagram showing magnetization that is performed on each member when a quadrupole permanent magnet is fixed to the securing member;

FIG. 11 is a diagram showing magnetization that is performed on each member when a bipolar permanent magnet is fixed to the securing member;

FIG. 12 shows another example of the method for installing the permanent magnets (1);

FIG. 13 shows another example of the method for installing the permanent magnets (2);

FIG. 14 shows another example of the method for installing the permanent magnets (3);

FIG. 15 shows another example of the method for installing the permanent magnets (4);

FIG. 16 is a longitudinal section showing the periphery of a touchdown bearing according to a third embodiment (1);

FIG. 17 is a longitudinal section showing the periphery of the touchdown bearing according to the third embodiment (2);

FIG. 18 is a diagram showing the relationship between the rotation angle of the inner ring around a central axis and the magnetic flux density obtained as a result of magnetization;

FIG. 19 is a diagram showing the relationship between the rotation angle of the inner ring around the central axis and the magnetic flux density obtained as a result of magnetization;

FIG. 20 is a diagram showing magnetization of the inner ring and the outer ring when a bipolar motor is used;

FIG. 21 is a diagram showing magnetization of the inner ring and the outer ring when a quadrupole motor is used;

FIG. 22 shows a magnetization method of the touchdown bearing (using a magnetizer configured with an electromagnet);

FIG. 23 shows the magnetization method of the touchdown bearing (using a magnetizer configured with a permanent magnet);

FIG. 24 is a magnetization method of the securing member (using a magnetizer configured with an electromagnet);

FIG. 25 is a magnetization method of the securing member (using a magnetizer configured with a permanent magnet);

FIG. 26 is a longitudinal section showing the periphery of a touchdown bearing according to a fourth embodiment;

FIG. 27 shows an example of a rotating body of an outer type to which the present disclosure can be applied; and

FIG. 28 shows the conventional touchdown bearing.

### DETAILED DESCRIPTION

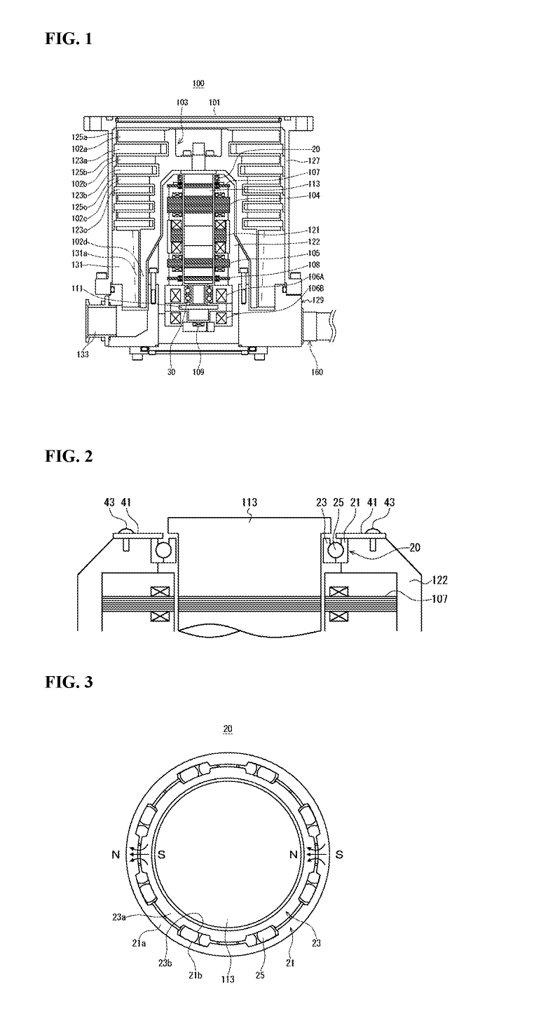

A first embodiment of the present disclosure is described hereinafter. FIG. 1 is a longitudinal section of a turbo-molecular pump according to the present embodiment. As shown in FIG. 1, a turbo-molecular pump 100 has an inlet port 101 at the upper end of a cylindrical outer cylinder 127. The inside of the outer cylinder 127 is a rotating body 103 in which a plurality of rotary blades 102a, 102b, 102c and the like configured as turbine blades for suctioning and exhausting the gas are formed radially in the form of multiple steps on a circumferential portion. A rotor shaft 113 is provided at the center of the rotating body 103. The rotor shaft 113 is supported in a levitated state and has its position controlled by, for example, a 5-axis control magnetic bearing.

Four upper radial electromagnets 104 are arranged in pairs along an X-axis and a Y-axis which are radial coordinate axes of the rotor shaft 113 and orthogonal to each other. Upper radial sensors 107 configured with four electromagnets are provided in the proximity of the upper radial electromagnets 104 so as to correspond thereto. The upper radial sensors 107 detect a radial displacement of the rotating body 103 and transmit a signal indicating the radial displacement to a control device, not shown.

Based on the displacement signal transmitted by the upper radial sensors 107, the control device controls the excitation of the upper radial electromagnets 104 by means of a compensating circuit having a PID adjustment function, and adjusts the upper radial position of the rotor shaft 113. The rotor shaft 113 is made out of high-magnetic permeability material (such as iron) so is attracted by the magnetic force of the upper radial electromagnets 104. This adjustment is performed in the X-axis direction and the Y-axis direction separately.

Lower radial electromagnets 105 and lower radial sensors 108 are disposed in the same manner as the upper radial electromagnets 104 and the upper radial sensors 107, and the lower radial position of the rotor shaft 113 is adjusted in the same manner as the upper radial position thereof.

Axial electromagnets 106A, 106B are disposed above and below a circular metal disc 111 that is provided in the lower portion of the rotor shaft 113. The metal disc 111 is made out of high-magnetic permeability material such as iron. An axial sensor 109 is provided for the purpose of detecting an axial displacement of the rotor shaft 113, and an axial displacement signal corresponding to the axial displacement is transmitted to the control device.

Based on this axial displacement signal, the excitation of the axial electromagnets 106A, 106B is controlled by means of the compensating circuit having a PID adjustment function. The magnetic force of the axial electromagnet 106A attracts the metal disc 111 upward, while the magnetic force of the axial electromagnet 106B attracts the metal disc 111 downward.

The control device appropriately adjusts the magnetic forces of the axial electromagnets 106A, 106B acting on the metal disc 111, to keep the rotor shaft 113 magnetically levitated in the axial direction and in a non-contact state in the space. A touchdown bearing 20, described hereinafter in detail, is provided at the upper end portion of a stator column 122 disposed between the upper radial sensors 107 and the rotating body 103. A touchdown bearing 30 is provided below the lower radial sensors 108.

The touchdown bearing 20 and the touchdown bearing 30 are configured with ball bearings. The touchdown bearing 20 and the touchdown bearing 30 are provided to allow the rotating body 103 to shift safely from its levitated state to a non-levitated state when the rotating body 103 can no longer be magnetically levitated for some reason such as when the rotating body 103 rotates abnormally or when a power outage occurs.

A motor 121 is a high-frequency motor and is controlled by the control device to drive the rotor shaft 113 rotationally by using an electromagnetic force acting between the motor 121 and the rotor shaft 113. In a case where the motor 121 is a DC brushless motor, permanent magnets are attached to or embedded in the circumference of the rotor shaft 113 to function as the rotors.

A plurality of fixed blades 123a, 123b, 123c and the like are arranged with small distances to the rotary blades 102a, 102b, 102c and the like. The rotary blades 102a, 102b, 102c and the like each transfer the exhaust gas molecules downward by collision and are therefore inclined by a predetermined angle from a plane perpendicular to the axis of the rotor shaft 113.

The fixed blades 123, too, are inclined by a predetermined angle from the plane perpendicular to the axis of the rotor shaft 113 and are arranged alternately with the rotary blades 102, facing the inside of the outer cylinder 127. One end of each fixed blade 123 is inserted and supported between a plurality of stacked fixed blade spacers 125a, 125b, 125c and the like.

The fixed blade spacers 125 are each a ring-shaped member and made of a metal such as aluminum, iron, stainless steel, copper, or an alloy containing these metals.

The outer cylinder 127 is fixed to the outer circumferences of the fixed blade spacers 125 with a small distance therebetween. The bottom portion of the outer cylinder 127 is provided with a base portion 129, and a threaded spacer 131 is disposed between the lower portion of the fixed blade spacers 125 and the base portion 129. An outlet port 133 is formed below the threaded spacer 131 inside the base portion 129 and is communicated to the outside.

The threaded spacer 131 is a cylindrical member made of a metal such as aluminum, copper, stainless steel, iron, or an alloy containing these metals, and has a plurality of spiral thread grooves 131a engraved on the inner circumferential surface of the threaded spacer 131. The direction of the spiral of each thread groove 131a is the direction in which the exhaust gas molecules are transferred toward the outlet port 133 when moving in the direction of rotation of the rotating body 103.

A rotary blade 102d is suspended at the lowest portion leading to the rotary blades 102a, 102b, 102c and the like of the rotating body 103. The outer circumferential surface of this rotary blade 102d is shaped into a cylinder, protrudes toward the inner circumferential surface of the threaded spacer 131, and is positioned adjacent to the inner circumferential surface of the threaded spacer 131 with a predetermined distance therebetween. The base portion 129 is a disc-shaped member configuring the bottom portion of the turbo-molecular pump 100 and is generally made out of a metal such as iron, aluminum, or stainless steel.

An electric component that is configured with the motor 121, lower radial electromagnets 105, lower radial sensors 108, upper radial electromagnets 104, upper radial sensors 107 and the like is surrounded with the stator column 122 and the inside of the electric component is kept at a predetermined pressure by purge gas so that the gas suctioned through the inlet port 101 does not enter the electric component.

According to this configuration, when the rotary blades 102 are driven by the motor 121 rotationally along with the rotor shaft 113, the exhaust gas from a chamber is suctioned through the inlet port 101 by the actions of the rotary blades 102 and the fixed blades 123. The exhaust gas suctioned through the inlet port 101 is transferred to the base portion 129 through the space between the rotary blades 102 and the fixed blades 123.

The exhaust gas that is transferred to the threaded spacer 131 is sent to the outlet port 133 by being guided by the thread grooves 131a. FIGS. 2 and 3 each show a configuration diagram of the touchdown bearing 20. FIG. 2 is a longitudinal section showing the periphery of the touchdown bearing, and FIG. 3 is a plan view of the touchdown bearing.

The touchdown bearing 20 located on the upper side is now described with reference to FIGS. 2 and 3. The touchdown bearing 30 located on the lower side can have the same configuration as the touchdown bearing 20. The touchdown bearing 20 according to the present embodiment can be applied to a hydrodynamic bearing as well (the same hereinafter). As shown in FIGS. 2 and 3, the touchdown bearing 20 is attached to the upper end portion of the stator column 122 by a ring-shaped securing member 41. The securing member 41 is secured to the stator column 122 by bolts 43. The touchdown bearing 20 is provided with an outer ring 21 that has a plurality of projections 21a (corresponding to the third projection) projecting radially inward. A plurality of depressions 21b are formed circumferentially between the projections 21 a.

The touchdown bearing 20 is also provided with an inner ring 23 that has projections 23a (corresponding to the third projection) projecting radially outward to oppose the projections 21a of the outer ring 21. A plurality of depressions 23b are formed circumferentially between the projections 23a. As shown in FIG. 3, parts of balls 25 can be seen through the spaces partitioned by the depressions 21b and depressions 23b.

Examples of the measurements of the touchdown bearing 20 are now described. When the outer diameter of the outer ring 21 is 60 mm and the inner diameter of the inner ring 23 is 40 mm, the length of the projections 21a and the projections 23a in the circumferential direction is approximately 5 mm and the gaps between the projections 21a and the projections 23a are each approximately 0.5 mm. The diameter of a ball 25 is approximately 6 mm, and the radial length measured when the depressions 21b and the depressions 23b are brought to oppose each other is approximately 3 mm.

The effects of the first embodiment of the present disclosure are described next. When assembling the turbo-molecular pump, the permanent magnets of the motor 121 that are provided in the rotor shaft 113 pass through the inside of the touchdown bearing 20. In so doing, the projections 23a of the inner ring 23 and the projections 21a of the outer ring 21 are strongly magnetized because these projections oppose each other with small gaps therebetween. In this case, the material of the balls 25 may or may not be magnetic. In either case, these projections are strongly magnetized. The motor 121 can be configured with two or four magnetic poles if it is a permanent magnet motor. The motor 121 may also be a surface permanent magnet (SPM) motor in which the permanent magnets are attached to a surface of the rotor shaft 113 or an interior permanent magnet (IPM) motor in which the permanent magnets are embedded.

As a result of intensively magnetizing the projections 23a of the inner ring 23 and the projections 21a of the outer ring 21, an attractive force is generated as a strong positioning force between these projections. Therefore, even when a rotational momentum is generated between the rotor shaft 113 and the inner ring 23 as a result of the touchdown bearing 20 rotating in conjunction with the rotor shaft 113, such a rotational momentum can be inhibited substantially by a strong holding torque. In other words, because the projections 23a and the projections 21a are magnetized to focus the magnetic flux thereto, even when a rotational momentum is applied to the inner ring 23 of the touchdown bearing 20 as a result of the rotation of the rotating body 103, the co-rotation does not occur due to the large holding torque.

Moreover, when the rotating body 103 operates as the original protective bearing due to malfunction or the like of the magnetic bearing, the rotating body 103 rotates without difficulties because a torque equivalent to or greater than the holding torque is applied to the touchdown bearing 20. Furthermore, when the rotating body 103 starts rotating in resistance to the holding torque, a particularly large brake torque does not occur, which makes the touchdown bearing 20 less likely to suffer seizing.

Although a conventional pump that uses a less durable touchdown bearing with metal balls could not utilize a durable touchdown bearing with ceramic balls due to the co-rotation, a touchdown bearing with ceramic balls can be used in such a pump as well.

The inner ring 23 and the outer ring 21 each have a C-shaped longitudinal section and have upper and lower surfaces. The depressions and projections of the touchdown bearing 20 may be formed on the upper surfaces and/or the lower surfaces of the inner ring 23 and the outer ring 21. As described above, the projections 23a of the inner ring 23 and the projections 21a of the inner ring 21 are magnetized using the permanent magnets of the motor 121. Other methods for magnetizing the projections 23a of the inner ring 23 and the projections 21a of the outer ring 21 are described hereinafter.

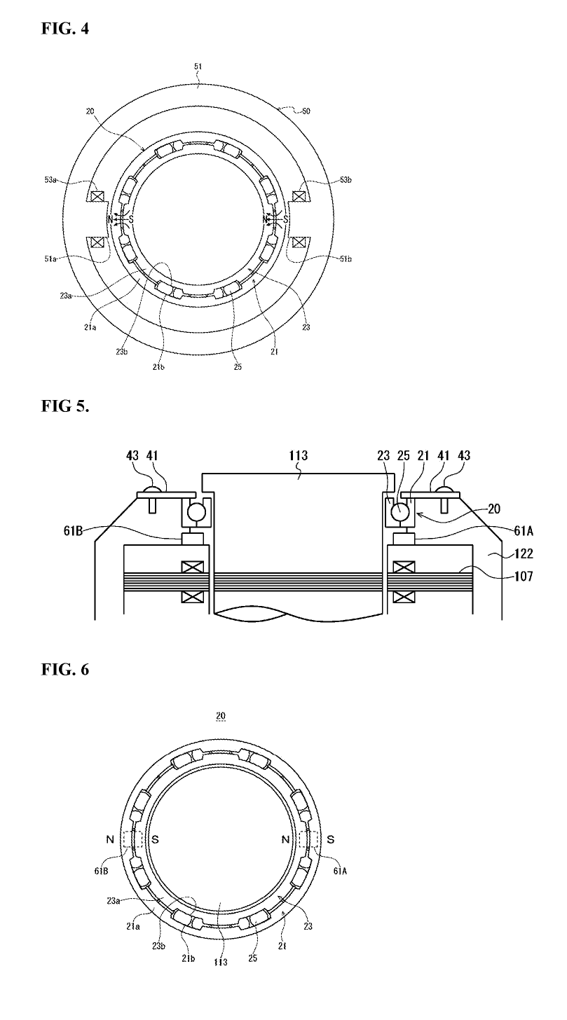

The first method is a method for using a magnetizer to forcibly magnetize the projections, as shown in FIG. 4, in a case where the passage of the permanent magnets of the motor 121 through the inside of the touchdown bearing 20 is not enough for a strong magnetic flux to pass through the outer ring 21. Specifically, a magnetizer 50 is disposed on the outer circumference of the touchdown bearing 20. The magnetizer 50 is provided with a tooth portion 51a and a tooth portion 51b in, for example, two locations, the tooth portions projecting toward the inside of an annular yoke core portion 51. A coil 53a and a coil 53b are wrapped around the tooth portion 51a and the tooth portion 51b respectively, thereby generating a magnetic flux flowing to the left in the diagram.

The tooth portion 51a and the tooth portion 51b are positioned so as to be in alignment with the projections 23a of the inner ring 23 and the projections 21a of the outer ring 21 of the touchdown bearing 20. By exciting the coil 53a and the coil 53b through application of an electric current thereto, a strong magnetic field is generated in the tooth portions 51a and 51b of the touchdown bearing 20, magnetizing the sections between the projections 23a of the inner ring 23 and the projections 21a of the outer ring 21. The number of tooth portions is not limited to two, and therefore may be one. Alternatively, a large number of tooth portions may be provided and the sections between the projections 23a of the inner ring 23 and the projections 21a of the outer ring 21 may be magnetized at once.

The second method is a method for constantly magnetizing the touchdown bearing 20 by using small permanent magnets provided in the vicinity of the touchdown bearing 20, with the polarities thereof being oriented in the radial direction, as shown in FIGS. 5 and 6. FIG. 5 is a longitudinal section showing the periphery of the touchdown bearing, and FIG. 6 is a transmissive layout drawing showing the touchdown bearing from above.

Specifically, small permanent magnets 61A and 61B are provided immediately below the projections 23a of the inner ring 23 and the projections 21a of the outer ring 21 of the touchdown bearing 20, with the polarities thereof being oriented in the radial direction. The projections 23a of the inner ring 23 and the projections 21a of the outer ring 21 are stably magnetized by allowing the magnetic flux of the permanent magnet 61A and permanent magnet 61B to constantly pass through the touchdown bearing 20.

The present embodiment explains that both the inner ring 23 and the outer ring 21 are provided with depressions and projections. However, the depressions and projections do not have to be formed in both the inner ring 23 and the outer ring 21 but may be formed on the surface of the securing member pressing the bearing so as to face each other, the surface of the securing member facing at least either the inner ring 23 or the outer ring 21 of the touchdown bearing 20.

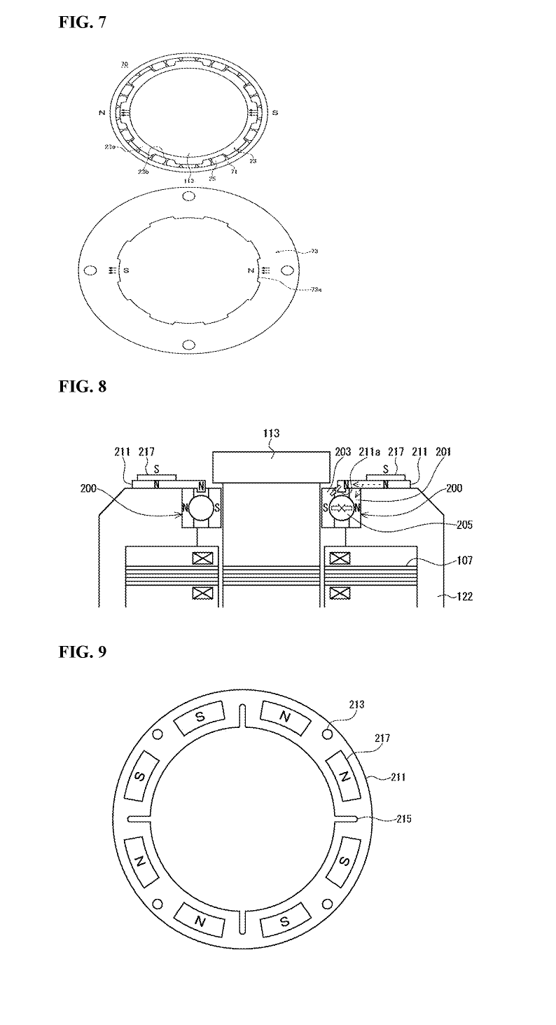

Specifically, as shown in FIG. 7, the inner ring 23 of a touchdown bearing 70 is provided with the projections 23a same as those shown in FIG. 3. However, an outer ring 71 does not have any projections. Projections 73a (same as the fourth projection) that project toward the inner side of a securing member 73 are provided so as to be stacked on the outer ring 71. The same effect as that of the touchdown bearing 20 shown in FIG. 3 can be achieved by magnetizing the projections 23a and the projections 73a using the methods described above.

Contrary to the example shown in FIG. 7, projections projecting toward the outside of the securing member 73 and projections projecting toward the inner side of the outer ring 71, although not shown, may be magnetized as well.

A second embodiment of the present disclosure is described next. FIG. 8 is a longitudinal section showing the periphery of a touchdown bearing according to the second embodiment. A touchdown bearing 200 is embedded in the upper portion of the stator column 122. The touchdown bearing 200 is configured with a ball bearing. An annular securing member 211 is fixed to the upper ends of the stator column 122 and the touchdown bearing 200 by bolts, not shown.

FIG. 9 is a plan view of the securing member 211. The bolts are inserted into bolt holes 213. Slits 215 are formed in the radial direction at four sections on the inner side of the securing member 211. However, these slits 215 may be formed on the outside of the securing member 211. The slits 215 are each shaped into a long groove but may each be formed into a triangle or other predetermined shape as long as it forms a notch.

As shown in FIG. 9, a pair of permanent magnets 217 of the same polarity is fixed to the upper surface of each of the four regions partitioned by the slits 215 of the securing member 211. The polarity of the permanent magnets 217 is axially oriented. The permanent magnets 217 are provided such that the upper polarity switches between the N-pole and the S-pole alternately in each of the adjacent regions partitioned by the slits 215.

Although FIG. 9 illustrates that a pair of permanent magnets 217 is provided on the upper surface of each of the four regions partitioned by the slits 215, the number of permanent magnets 217 is not limited to two. One, three or more permanent magnets may be provided as long as the permanent magnets share the same polarity throughout the regions.

The inner rim of the securing member 211 has projections 211a that are formed circumferentially downward (same as the first projection) in order to prevent the balls 205 from popping out of the space between an outer ring 201 and an inner ring 203 that are formed at the time of manufacture of the touchdown bearing 200.

According to this configuration, it is preferred that the securing member 211 be made of ferromagnetic material (SUS420J2, etc.). In the present embodiment, the reason why the securing member 211 is divided into four regions using the slits 215 is because the number of magnetic poles of the motor is four.

The slits 215 are provided for the purpose of retarding leakage of the magnetic flux between the magnetic poles of the adjacent magnets. In other words, providing the slits leads to an increase of the magnetic resistance, making it difficult for the magnetic flux to pass through the slits between the regions adjacent to each other.

In a case where the bottom surfaces of the permanent magnets 217 are the N-poles as shown in FIG. 8, the securing member 211 and the outer ring 201 of the touchdown bearing 200 are magnetized to N-pole. In a case where the material of the balls 205 is magnetic such as iron or SUS440, the inner ring 203 is magnetized to S-pole. Consequently, an attractive force is generated between the outer ring 201 and the inner ring 203.

A predetermined clearance is present between the securing member 211 and the inner ring 203 of the touchdown bearing 200. A part of a projection 211a projecting toward the inner end of the securing member 211 is magnetized to N-pole, and a part of the projection 21 la near the inner ring 203 is magnetized to S-pole, generating an attractive force between the projection 211a and the inner ring 203 as well.

Therefore, as with the first embodiment, the co-rotation does not occur because the holding torque is large, even when a rotational momentum is applied to the inner ring 203 of the touchdown bearing 200 as a result of the rotation of the rotating body 103.

Moreover, when the rotating body 103 operates as the original protective bearing due to malfunction or the like of the magnetic bearing, the rotating body 103 rotates without difficulties because a torque/fore equivalent to or greater than the holding torque is applied to the touchdown bearing 200. Furthermore, when the rotating body 103 starts rotating in resistance to the holding torque, a particularly large brake torque does not occur, which makes the touchdown bearing 200 less likely to suffer seizing.

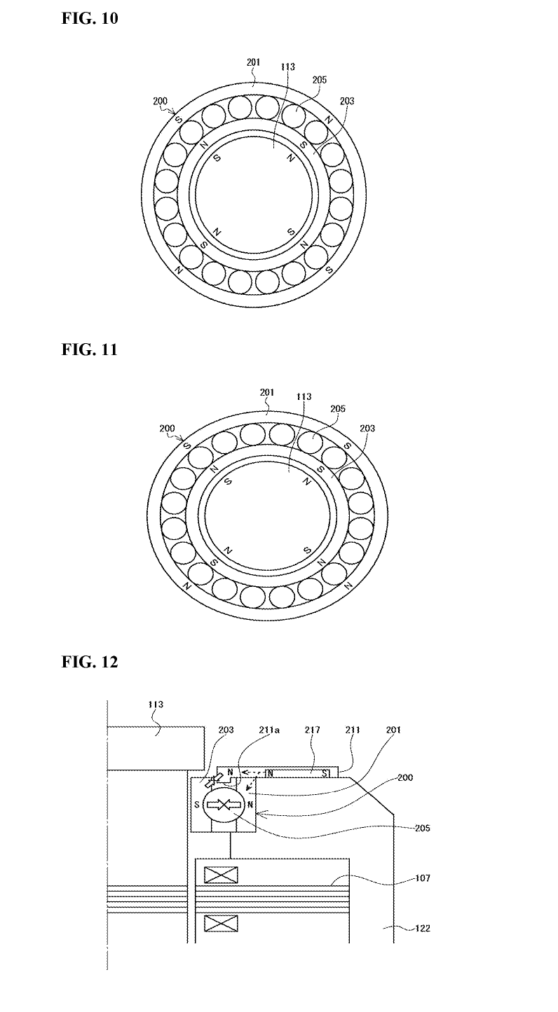

Next is described the reason why the permanent magnets 217, which have the same number of magnetic poles as the motor, are installed on the securing member 211. FIG. 10 shows magnetization that is performed on each member when quadrupole permanent magnets 217 are fixed to the securing member 211 as in the present embodiment. Specifically, the outer ring 201 of the touchdown bearing 200 is magnetized by the permanent magnets 217 on the securing member 211 and therefore magnetized to four poles.

The inner ring 203, on the other hand, is magnetized to four poles because the permanent magnets of the motor 121, which are provided in the rotor shaft 113, are quadrupole when assembling the turbo-molecular pump. Because the inner ring 203 and the outer ring 201 attract each other with the four poles, a sufficient stopping torque can be generated.

An example of fixing bipolar permanent magnets 217 onto the securing member 211 is considered. FIG. 11 shows magnetization performed on each member according to this example. The outer ring 201 is magnetized to two poles by the permanent magnets 217, as shown in FIG. 11. The inner ring 203, on the other hand, is magnetized to four poles, as described above. Therefore, while an attractive force acts on the left half of the touchdown bearing 200 between the inner ring 203 and outer ring 201, a repulsive force acts on the right half. Such imbalance cannot create a sufficient stop force. For this reason, it is preferred that the permanent magnets 217 having the same number of magnetic poles as the motor be installed on the securing member 211.

Note that the magnetic force of the permanent magnets 217 can be changed by changing, for example, the material thereof from ferrite to rare earth. The level of the holding torque can be adjusted according to need, by changing the magnetic force of the permanent magnets 217.

Another example of the method for installing the permanent magnets is described next. FIGS. 8 and 9 each illustrate how the permanent magnets 217 are installed on the upper surface of the securing member 211. However, as shown in FIG. 12, the permanent magnets 217 may be embedded horizontally in the bottom surface on the inner side of the securing member 211. The permanent magnets 217 each have, for example, a polarity in which the N-pole is oriented radially inward, and the S-pole radially outward. In this case as well, the inner ring 203, the outer ring 201, and the projections 211a projecting toward the inner end of the securing member 211, are magnetized in the same manner as in FIGS. 8 and 9. Therefore, the same effects as those of the second embodiment illustrated in FIGS. 8 and 9 can be achieved. In the configuration shown in FIG. 12 as well, it is preferred that the slits 215 be formed (same hereinafter with respect to each diagram).

As shown in FIG. 13, the permanent magnets 217 may be embedded in a groove 219 that is cut horizontally on the upper surface the stator column 122. In this case, the permanent magnets 217 each have a polarity in which, for example, the N-pole is oriented toward the upper surface, and the S-pole toward the lower surface. Alternatively, as shown in FIG. 14, the permanent magnets 217 may be embedded in a groove 220 that is cut vertically in the upper portion of the stator column 122 in the outer circumference of the touchdown bearing 200. The permanent magnets 217 each have a polarity in which, for example, the N-pole is oriented radially inward, and the S-pole radially outward. In the configuration shown in FIGS. 13 and 14 as well, the inner ring 203, the outer ring 201, and the projections 211a of the securing member 211, are magnetized in the same manner as in FIGS. 8 and 9. Therefore, the same effects as those of the second embodiment illustrated in FIGS. 8 and 9 can be achieved.

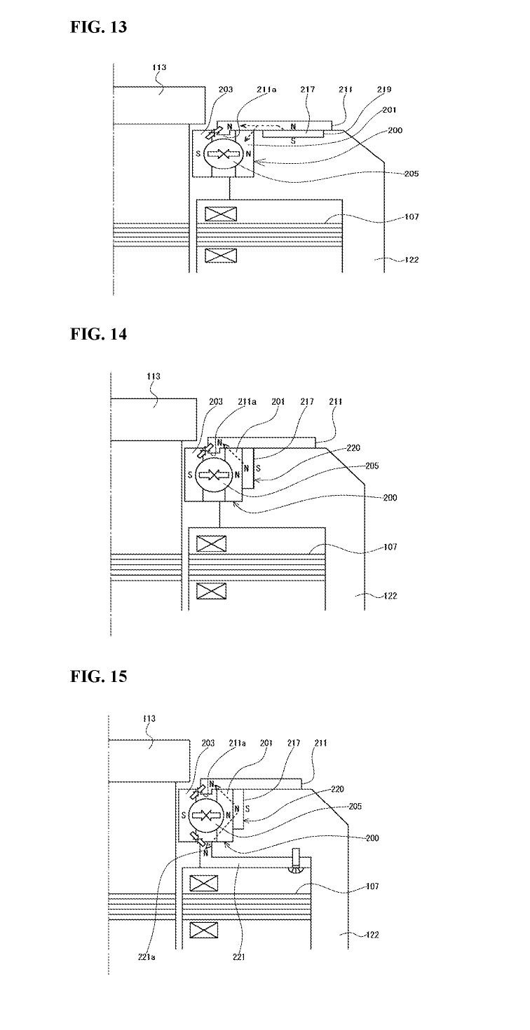

FIG. 15 shows the configuration shown in FIG. 14 and a configuration in which a ferromagnetic magnetic member 221 exhibiting ferromagnetism is provide at the lower end portion of the touchdown bearing 200. The magnetic member 221 is an annular member that is disposed across the stator column 122, on the opposite side to the securing member 211. The inner rim of the magnetic member 221 projects axially. The magnetic member 221 has an L-shaped longitudinal section.

This magnetic member 221 has a tip projection 221a (same as the second projection) that opposes a ball 205 of the touchdown bearing 200 at the middle position between the inner ring 203 and the outer ring 201. Specifically, the tip projection 221a is disposed across the ball 205, on the opposite side to a projection 211a. The magnetic member 221 is secured to the inside of the stator column 122 by bolts 223.

When the radially inward portion of a permanent magnet 217 is magnetized to N-pole, the outer ring 201 is magnetized to N-pole and the inner ring 203 is magnetized to S-pole. In this case, the projection 211a of the securing member 211 and the tip projection 221a of the magnetic member 221 are magnetized to N-pole by the magnetic flux of the permanent magnet 217.

Therefore, in addition to the magnetic attractive force acting between the inner ring 203 and the outer ring 201 of the touchdown bearing 200, magnetic attractive forces are generated between the projection 211a of the securing member 211 and the inner ring 203 as well as between the tip projection 221a of the magnetic member 221 and the inner ring 203. Therefore, the holding torque can be enlarged, further preventing the co-rotation. In a case where the magnetic attractive force between the projection 211a of the securing member 211 and the inner ring 203 and the magnetic attractive force between the tip projection 221a of the magnetic member 221 and the inner ring 203 are large, the ball 205 may be made out of non-magnetic material such as ceramic material. Also, the magnetic member 221 itself may be configured with a permanent magnet.

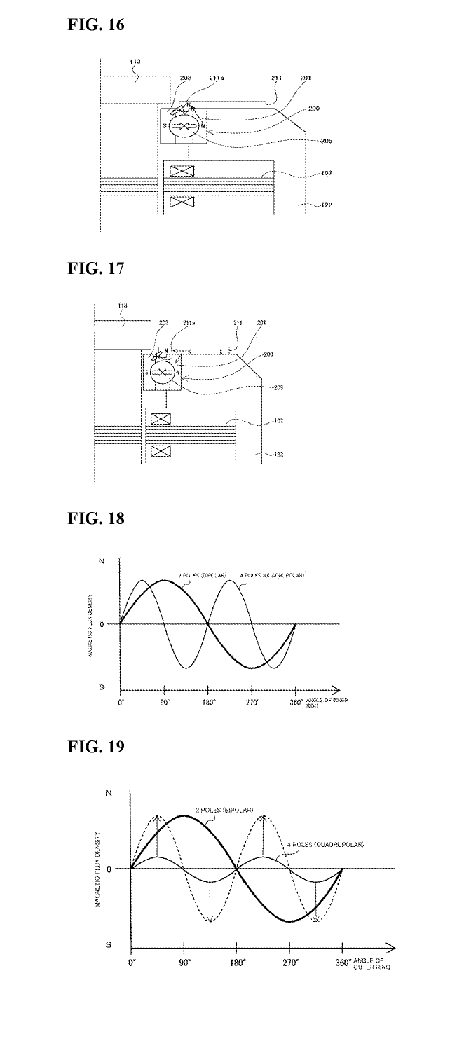

A third embodiment of the present disclosure is described next. FIGS. 16 and 17 are each a longitudinal section showing the periphery of a touchdown bearing according to the third embodiment. In the second embodiment, the permanent magnets are used to magnetize the inner ring 203 and the outer ring 201 of the touchdown bearing 200. In the third embodiment, on the other hand, a magnetized member is used in place of a permanent magnet. As shown in FIG. 16, the outer ring 201 of the touchdown bearing 200 is magnetized by application of a strong magnetic field from the outside prior to assembly. Therefore, the projections 211a of the securing member 211 are magnetized to, for example, N-pole by the outer ring 201. The inner ring 203, on the other hand, is magnetized strongly to S-pole when the balls 205 are magnetic. Thus, without using permanent magnets, co-rotation of the inner ring 203 can be prevented based on the same principle as the second embodiment.

Instead of magnetizing the outer ring 201 of the touchdown bearing 200, the securing member 211 may forcibly be magnetized, as shown in FIG. 17. It is preferred that the securing member 211 be made out of high coercivity material (material for quenching S45C, SUS440C). For example, the securing member 211 is magnetized such that the radially inside thereof is oriented toward N-pole and the radially outside toward S-pole. In this case, the projections 211a of the securing member 211 are magnetized to N-pole. Similarly, the outer ring 201 is magnetized to N-pole.

When the balls 205 are magnetic, the inner ring 203 is magnetized strongly to S-pole. Therefore, co-rotation of the inner ring 203 can be prevented without using permanent magnets. However, the same effects can be achieved by disposing the securing member 211 such that, for example, the upper surface faces the S-pole and the lower surface faces the N-pole.

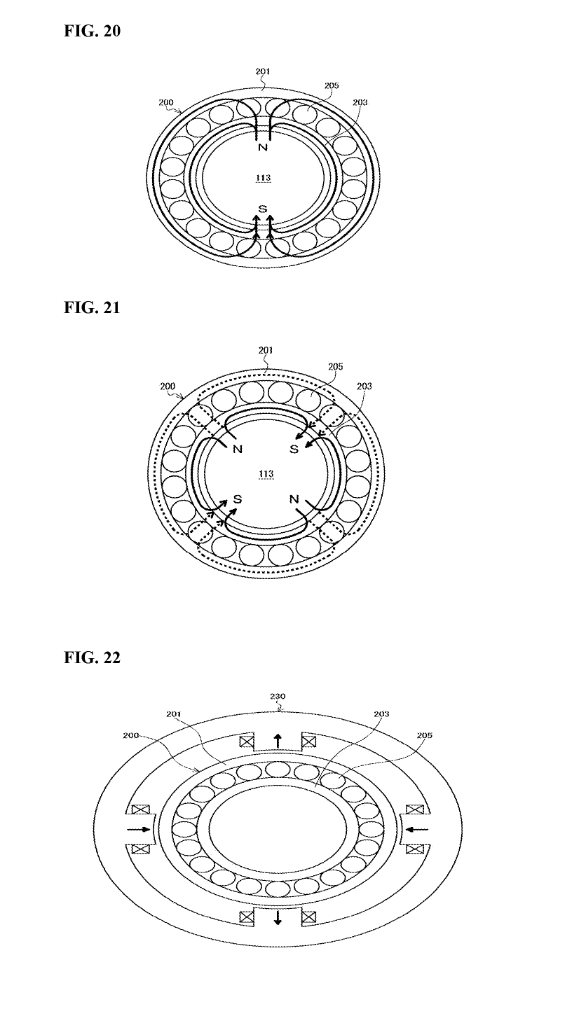

Magnetization of the touchdown bearing is considered next. When assembling the turbo-molecular pump, the permanent magnets of the motor 121 that are provided in the rotor shaft 113 pass through the inner side of the touchdown bearing 200. FIG. 18 shows the relationship between the rotation angle of the inner ring 203 around the central axis and the magnetic flux density obtained as a result of magnetization. FIG. 19 shows the relationship between the rotation angle of the outer ring 201 around the central axis and the magnetic flux density as a result of magnetization when the balls 205 are magnetic.

As can be seen from FIGS. 18 and 19, in a case where the motor 121 is bipolar, the magnetic flux density obtained as a result of magnetization of the inner ring 203 and outer ring 201 is substantially equal to the rotation angle. The reason is described with reference to FIG. 20.

As shown in FIG. 20, the magnetic flux generated from the N-pole of a permanent magnet of the motor 121 that is provided in the rotor shaft 113 divides into right and left symmetrically after passing through the inner ring 203, the balls 205 and the outer ring 201, and returns to the S-pole on the other side. Because the magnetic flux passes through the outer ring 201 as well, the outer ring 201 is magnetized to approximately the same extent the inner ring 203 is. Therefore, as long as the level of magnetization of the outer ring 201 is great, co-rotation of the inner ring 203 can be prevented.

As can be seen in FIGS. 18 and 19, in a case where the motor 121 is quadrupole, the magnetic flux density obtained as a result of magnetization of the inner ring 203 is smaller than the magnetic flux density obtained as a result of magnetization of the outer ring 201. The reason is described with reference to FIG. 21. As shown in FIG. 21, the magnetic flux generated from the N-pole of a permanent magnet of the motor 121 that is provided in the rotor shaft 113 divides into right and left at the inner ring 203 and returns to the adjacent S-pole. For this reason, the outer ring 201 is not much magnetized. The outer ring 201 therefore needs to forcibly magnetized from the outside to compensate for the magnetic flux density. The dotted line in FIG. 19 represents the magnetic flux density that is compensated by the forcible magnetization.

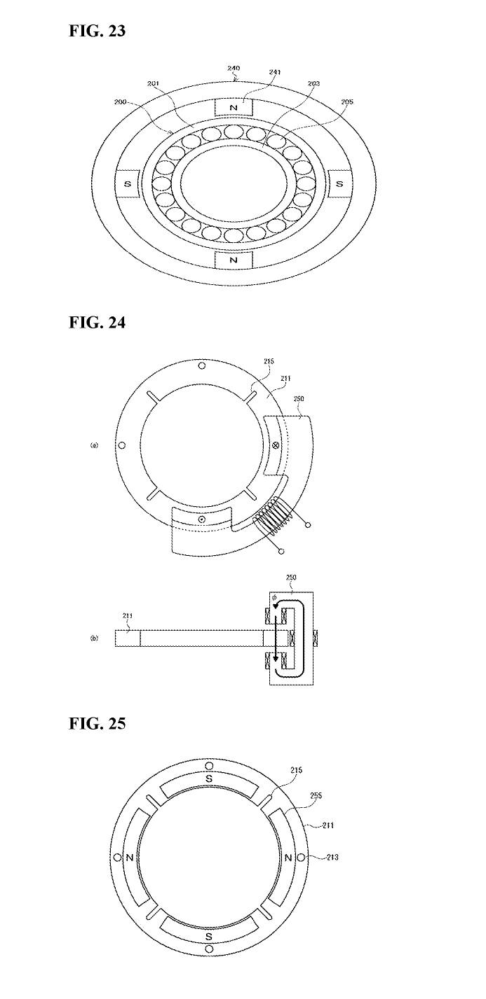

A method for magnetizing the touchdown bearing 200 may use a magnetizer 230 configured with an electromagnet as shown in FIG. 22 or a magnetizer 240 configured with a permanent magnet as shown in FIG. 23. The magnetizer 230 shown in FIG. 22 has four coils arranged at equal intervals to achieve quadrupole magnetization. The magnetizer 230 operates such that the polarities of the adjacent coils become opposite to each other. The magnetizer 230 externally magnetizes the outer ring 201 of the touchdown bearing 200 to four poles at once.

The magnetizer 240 shown in FIG. 23, on the other hand, has permanent magnets 241 instead of coils. The polarities of the adjacent permanent magnets are opposite to each other. The magnetizer 240 externally magnetizes the outer ring 201 of the touchdown bearing 200 to four poles at once by coming into contact with or approaching the touchdown bearing 200.

A method for magnetizing the securing member 211 may use a magnetizer 250 configured with an electromagnet as shown in the plan view of FIG. 24A and the longitudinal section of FIG. 24B or may bring a permanent magnet 255 into contact with the top of the securing member 211 as shown in the plan view of FIG. 25. The magnetizer 250 shown in FIG. 24 corresponds to an example of a bipolar motor, but this configuration applies similarly to a motor with one, three or more poles. The foregoing configuration can achieve the same effects as those of the first embodiment such as preventing co-rotation.

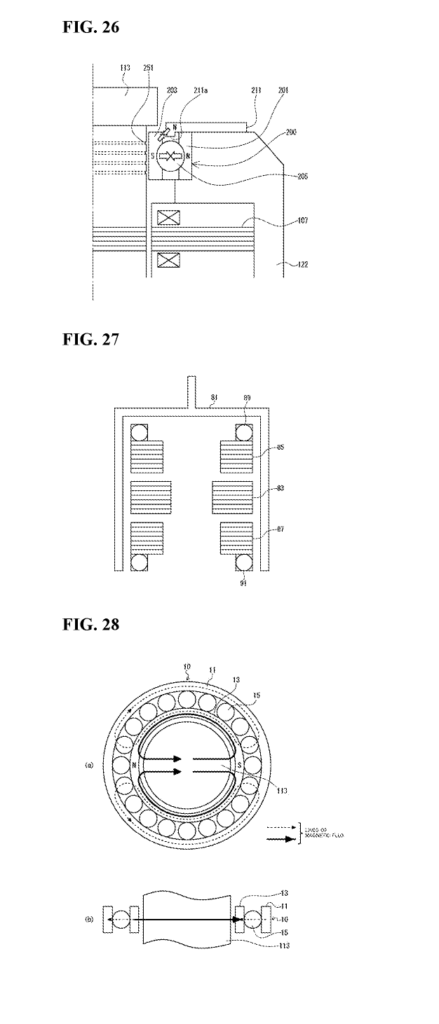

A fourth embodiment of the present disclosure is described next. FIG. 26 is a longitudinal section showing the periphery of a touchdown bearing according to the fourth embodiment. In the fourth embodiment, one or more cutout grooves 251 are provided circumferentially on the surface of the rotor shaft 113 where the rotor shaft 113 touches the inner ring 203 of the touchdown bearing 200. The cutout grooves 251 each have an angular cross section, a radial depth of 1 mm and an axial length of approximately 1 mm.

Operations of the fourth embodiment of the present disclosure are described next. The magnetic flux generated in the inner ring 203 of the touchdown bearing 200 intersects with the rotor shaft 113. When the rotor shaft 113 rotates, an electromotive force is generated on the surface of the rotor shaft 113 and an eddy current flows. In the present embodiment, the presence of the cutout grooves 251 limits the eddy current path that occurs on the surface of the rotor shaft 113, reducing the eddy current. This weakens the electromagnetic induction action that occurs between the rotor shaft 113 and the inner ring 203 of the touchdown bearing 200, resulting in a reduction of the rotational momentum which is a cause of co-rotation. The cutout grooves 251 are provided circumferentially as described above, but one or more cutout grooves 251 may be provided axially.

The co-rotation can be prevented more effectively by combining the configuration example of the fourth embodiment of the present disclosure with each of the configuration examples of the first to third embodiments. Such combination can reduce the magnetic forces of the permanent magnets 217 necessary to prevent the co-rotation, the outer ring 201 of the touchdown bearing 200 shown in FIG. 16 that functions as the magnetizing component of the third embodiment, or the securing member 211 shown in FIG. 17. Thus, the same effects as those of the first embodiment such as preventing co-rotation can be achieved.

Each of the foregoing embodiments has described a rotating body of an inner type, however, the present disclosure can be applied to a rotating body of an outer type shown in FIG. 27. As shown in FIG. 27, a cylindrical rotating body 81 is driven rotationally by a motor 83. Permanent magnets are provided at parts of the rotating body 81 that oppose the motor 83. A radial position controlling electromagnet 85 is provided above the motor 83 to control an upper radial position of the rotating body 81.

A radial position controlling electromagnet 87 is provided below the motor 83 to control a lower radial position of the rotating body 81. A touchdown bearing 89 is provided above the radial position controlling electromagnet 85. A touchdown bearing 91 is provided below the radial position controlling electromagnet 87. For the sake of simplicity, an axial position controlling electromagnet is not shown in FIG. 27. The touchdown bearing 89 and the touchdown bearing 91 are configured with ball bearings.

According to this configuration, the touchdown bearing 89 is magnetized in the same manner described above, when inserting the rotating body 81. The present embodiment, therefore, can similarly be applied to a rotating body of an outer type and a rotating body of an inner type.

### EXPLANATION OF REFERENCE NUMERALS

20, 70, 89, 91, 200: Touchdown bearing; 21, 71, 201: Outer ring; 21a, 23a, 73a: Projection; 21b, 23b: Depression; 23, 203: Inner ring; 25, 205: Ball; 41, 73: Securing member; 50: Magnetizer; 51: Yoke core portion; 51a, 51b: Tooth portion; 53a, 53b: Coil; 61A, 61B, 217, 241, 255: Permanent magnet; 81, 103: Rotating body; 83, 121: Motor; 100: Turbo-molecular pump; 113: Rotor shaft; 122: Stator column; 211: Securing member; 211a: Projection; 215: Slit; 219, 220: Groove; 221: Magnetic member; 221a: Tip projection; 230, 240, 250: Magnetizer; 251: Cutout groove.

1. A protective bearing for protecting a rotating body when the rotating body is stopped or when an abnormality occurs in a bearing, wherein at least a part of the protective bearing is magnetized by magnetizing means.

2. The protective bearing according to claim 1, wherein a securing member for securing the protective bearing is provided.

3. The protective bearing according to claim 2, wherein a first projection located between an inner ring and an outer ring of the protective bearing is formed in the securing member.

4. The protective bearing according to claim 2, further comprising a permanent magnet for magnetizing the protective bearing through the securing member or by coming into contact with the protective bearing.

5. The protective bearing according to claim 4, further comprising a second projection that is disposed on the opposite side to the first projection across a rolling element of the protective bearing, wherein the first projection and the second projection are magnetized by the permanent magnet.

6-11. (canceled)

12. The protective bearing according to claim 1, further comprising a third projection on at least either an outer circumference of an inner ring or an inner circumference of an outer ring.

13. The protective bearing according to claim 1, wherein a rolling element of the protective bearing is made of nonmagnetic material.

14. A bearing unit comprising:
a protective bearing for protecting a rotating body when the rotating body is stopped or when an abnormality occurs in a bearing, wherein:
at least a part of the protective bearing is magnetized with magnetizing means,
the rotating body is driven rotationally by a motor while being supported in a state of levitation,
the protective bearing protects the rotating body in a state of non-levitation,
the protective bearing has a third projection on at least either an outer circumference of the inner ring or an inner circumference of the outer ring, and
the third projection is magnetized by the magnetizing means.

15. The bearing unit according to claim 14, wherein the magnetizing means is a permanent magnet provided in the motor.

16. The bearing unit according to claim 14, wherein the magnetizing means is a magnetizer provided on an outer circumference of the protective bearing.

17. The bearing unit according to claim 14, wherein the magnetizing means is a permanent magnet that is provided in an upper portion or a lower portion of the protective bearing so as to have magnetic poles oriented in a radial direction.

18. The bearing unit according to claim 14, further comprising:
a securing member for securing the upper portion or lower portion of the protective bearing,
wherein a fourth projection opposing the third projection is provided in the securing member, and
the third projection and the fourth projection are magnetized by the magnetizing means.

19. A bearing unit, comprising:
a protective bearing for protecting a rotating body when the rotating body is stopped or when an abnormality occurs in a bearing, wherein at least part of the protective bearing is magnetized by magnetizing means; and
the rotating body that is driven rotationally by a motor while being supported in a state of levitation,
wherein at least one notched groove is formed on a surface of the rotating body that opposes the protective bearing.

20. A vacuum pump, comprising:
a protective bearing for protecting a rotating body when the rotating body is stopped or when an abnormality occurs in a bearing, wherein at least a part of the protective bearing is magnetized by magnetizing means.

21. A vacuum pump, comprising:
a bearing unit comprising:
a protective bearing for protecting a rotating body when the rotating body is stopped or when an abnormality occurs in a bearing, wherein:
at least a part of the protective bearing is magnetized with magnetizing means,
the rotating body is driven rotationally by a motor while being supported in a state of levitation,
the protective bearing protects the rotating body in a state of non-levitation,
the protective bearing has a third projection on at least either an outer circumference of the inner ring or an inner circumference of the outer ring, and
the third projection is magnetized by the magnetizing means.
